(19) United States
(12) Patent Application Publication
(10) Pub. No.: US 2003/0156938 A1
(43) Pub. Date: Aug. 21, 2003

(54) Apparatus for capturing and harnessing the energy from environmental wind

(76) Inventor: Nicholas A. Verini, Lafayette, CO (US)

Correspondence Address: John L. Isaac, Esq., Isaac & Associates, Suite 900, 143 Union Blvd., Lakewood, CO, 80228-1829, US

(21) Appl. No.: 10/077,403

(22) Filed: Feb. 15, 2002

(51) Int. Cl. F03D 7/00

(52) U.S. Cl. 415/4.2

(57) ABSTRACT

An apparatus is disclosed for capturing and converting wind energy to electrical energy. The apparatus includes a tower member arranged in the form of an elongated conduit having first and second end portions. A wind collector is provided and is associated with the conduit first end portion. The wind collector has an air inlet to capture environmental wind originating from one or more directions and then deflect the captured wind into the conduit to create an axial airflow therein. Finally, a wind turbine device is disposed at the conduit second end portion for receiving the airflow from the conduit in order to generate electricity therefrom.

### BACKGROUND OF THE INVENTION

1. Field of the Invention

The present invention relates generally to devices for converting wind energy to electrical energy and, more particularly, to systems utilizing wind driven turbine generators. Specifically, the present invention relates to devices adapted to capture environmental wind and harness its energy for residential use.

2. Description of the Prior Art

In the last several decades, considerable attention has been given to non-petroleum forms of energy generation and in particular to renewable forms of energy. Such renewable energy sources include biomass conversion systems, passive and active solar energy devices, and wind energy driven systems. Wind driven turbines and windmills have been used for centuries to capture energy and generate power. There have been constant efforts to increase the efficiency of and hence the energy production from wind turbines. However, to date it has been very difficult to generate significant energy from wind sources due to inefficiencies of wind turbine devices as well as the lack of prevalent winds on a consistent basis in many geographical locations.

Wind power is one of the most promising and cost-effective renewable energy technologies available today. Worldwide there are over 15,000megawatts of wind power installed, and in the USA approximately 4,500 megawatts will be installed by the year 2002. One advantage of wind power is that even though it is intermittent, it blows both day and night. All 50 U.S. states have sufficient wind to justify wind power turbines. One problem with the present standard wind turbine is that it needs to be located away from populous areas. This is due to the fact that homeowners to not want large blades spinning in their backyards over their heads. Such devices are expensive, large, loud, kill birds and somehow seem dangerous.

Windmill systems utilize wind driven generators having blades that are turned and powered by the passing of airflow from the wind. Examples of such wind driven generators are illustrated in U.S. Pat. No. 4,075,500, No. 4,309,146, No. 4, 324,985, No. 4,411,588 and No. 6,126385. The first successful attempt in the United States at producing electric power to feed a utility network using large-scale windmills was in Vermont which system utilized a two-bladed windmill mounted on a 150-foot tower. The 175-foot blades were pitch controlled and drove an AC alternator at constant speed. Other examples of such systems utilizing many large-scale windmills can be found in Wyoming and California. Additionally, there have been attempts to erect windmill towers by individual residences in order to generate power for a specific residential home. Again, a common problem with such systems is the lack of consistent prevalent winds to power the windmill blades. Moreover, significant noise problems were created by such windmill towers in residential neighborhoods, not to mention the unsightly nature of such devices.

High efficiency, compact wind turbines known as diffuser augmented wind turbines (DAWT) were developed by a number of companies. PCT patent applications No. NZ00/00020,No. NZ00/00128 and NZ0/00032 disclose examples of such compact turbine devices. While these devices have proven to be very effective in converting wind energy to electrical energy, there remains a need for systems which incorporate such wind turbine devices for use in areas where constant prevalent winds may not necessarily be present as well as systems which are adapted for use by individual residences in residential neighborhoods for their own power needs. The present invention addresses this significant problem.

### SUMMARY OF THE INVENTION

Accordingly, it is one object of the present invention to provide an improved wind energy conversion system.

It is another object of the present invention to provide an apparatus for capturing and harnessing the energy from environmental wind.

Yet another object of the present invention is to provide a wind energy conversion device capturing and redirecting wind airflow and converting the energy therefrom into electrical energy.

Still another object of the present invention is to provide a tower device for generating electrical energy for residential use by capturing and harnessing wind energy.

To achieve the foregoing and other objects and in accordance with the purpose of the present invention, as embodied and broadly described herein, an apparatus is disclosed for capturing and converting wind energy to electrical energy. The apparatus includes a tower member arranged in the form of an elongated conduit having first and second end portions. A wind collector is provided and is associated with the conduit first end portion. The wind collector has an air inlet to capture environmental wind originating from one or more directions and then deflect the captured wind into the conduit to create an axial airflow therein. Finally, a wind turbine device is disposed at the conduit second end portion for receiving the airflow from the conduit in order to generate electricity therefrom.

In one modification of the invention, the apparatus further includes an airflow velocity-sensing element disposed in the conduit for measuring the airflow speed therein. Moreover, an airflow speed control member is also disposed therein proximate the conduit first end portion to selectively restrict and dampen the speed of the airflow received by the turbine device from the conduit in response to variable speed changes in and gusts of environmental wind impacting the collector air inlet conduit. In one variation of this, the airflow speed control member may be in the form of a dampening device disposed in the conduit to prevent sudden impact of airflow onto the wind turbine device resulting from substantial gusts of environmental wind entering the wind collector, the dampening device being selectively movable between a full open position unaffecting conduit airflow speed to a full closed position blocking conduit airflow entirely.

In another modification of the invention, the wind collector is in the form of a housing communicating with the conduit first end portion, an air inlet assembly disposed in the housing and adapted to direct wind airflow into the housing, and a wind airflow deflection arrangement for retaining the wind airflow captured by the air inlet assembly within the housing and diverting it into the conduit. The air inlet assembly may preferably include a mechanism for preventing the entry of living creatures into the housing and may also be omni-directional.

In one modification form of the invention, the housing comprises a substantially cylindrical element, and the air inlet assembly is defined by a plurality of spaced openings disposed along the perimeter of the cylindrical element and accessing the interior thereof. In another modification, the housing still comprises a cylindrical element, but the air inlet assembly is in the form of an array of elongated paired shutters disposed about the perimeter of the cylindrical element. The paired shutters are adapted for movement between a closed position blocking access to the interior of the housing by both the absence of wind pressure against the exterior surfaces of the shutters and/or the presence of wind pressure against the interior surfaces of the shutters, and an open position for accessing the interior of the housing by radially inward rotation thereof in response to wind pressure against the exterior surfaces of the shutters.

In still another modification, the housing is in the form of an angular-shaped tubular element having first and second end sections and a curved angular central section therebetween. The first end section is coupled to the conduit first end portion for rotational movement relative thereto, and the second end section is the air inlet assembly in the form of an annular opening for receiving environmental wind directed thereinto, the curved angular central section comprising the wind airflow deflection arrangement portion of the wind collector. In one aspect of this particular modification, the collector further includes a sensing member mounted to the housing for detecting environmental wind direction and for rotating the air inlet assembly annular opening into the environmental wind airflow regardless of the direction from which the environmental wind airflow originates. Moreover, the collector may further include a mechanism for selectively fixing the rotational position of the first end section relative to the conduit first end portion to orient the air inlet assembly annular opening toward a predominant environmental wind direction in situations where the environmental conditions favor such a modification. Finally, the air inlet assembly of this particular modification may further include a plurality of louver fins disposed across said annular opening to control the flow of wind into the air inlet assembly.

In still another modification of the invention, the tower of the apparatus is in the form of a substantially vertical tube. Moreover, the tower tube may in one form further include a plurality of airflow turbulence control elements disposed therein to create laminar airflow along the length of the tower tube prior to the airflow impacting the wind turbine device.

In yet another modification of the invention, a wind energy conversion device is disclosed for capturing and redirecting wind airflow and converting the energy therefrom to electrical energy. The device includes a tower member arranged in the form of an elongated substantially hollow airflow conduit having first and second end portions. A wind collector is associated with the conduit first end portion and has an omni-directional air inlet to capture environmental wind originating from any compass direction and then deflect the captured wind into the conduit to create a substantially axial airflow therein. Airflow turbulence control elements are disposed within the conduit to create substantially laminar airflow along the length thereof. A wind turbine device is disposed at the conduit second end portion for receiving the substantially laminar airflow from the conduit to generate electricity therefrom.

In a further modification of the invention, the device further includes an airflow velocity sensing element disposed in the conduit for measuring the airflow speed therein, and an airflow speed control member disposed proximate the conduit first end portion to regulate the speed of the airflow in the conduit in response to variable speed changes in and gusts of environmental wind impacting the collector air inlet to prevent sudden speed changes in the airflow impacting the turbine device. In one form, the airflow speed control member may comprise a dampening device disposed in the conduit to prevent sudden impact of airflow onto said wind turbine device resulting from substantial gusts of environmental wind entering the wind collector, the dampening device being selectively movable between a full open position unaffecting conduit airflow speed to a full closed position blocking conduit airflow entirely. In addition, the device of the invention may be adapted for association with a residential housing unit with the tower member being in the form of a substantially vertical tube. Moreover, the tower member may be directly incorporated as an integral component of the residential housing unit with the conduit second end portion and wind turbine device being disposed at ground level. Finally, the wind collector air inlet may include a mechanism for preventing the entry of living creatures therein.

In yet another modification of the invention, a wind tower device is disclosed for generating electrical energy for residential use by capturing and harnessing wind energy. In this modification, the wind tower device includes a tower member arranged in the form of an elongated, substantially vertically oriented airflow conduit having first and second end portions. A wind collector is associated with the conduit first end portion and has an air inlet assembly adapted to capture local environmental wind along with a wind airflow deflection arrangement to deflect the captured wind into the conduit to create a substantially downward axial airflow therein. Airflow turbulence control elements are arranged within the conduit to create substantially laminar airflow along the length thereof. A wind turbine device is in turn disposed at the conduit second end portion proximate a ground surface for receiving the substantially laminar airflow from the conduit to generate electricity therefrom. An airflow velocity-sensing element is positioned in the conduit for measuring the airflow speed therein. Finally, an airflow speed control member is disposed proximate the conduit first end portion to regulate the speed of the airflow in the conduit in response to variable and gusting speed changes in the environmental wind impacting the collector air inlet to prevent sudden speed changes in the airflow impacting the turbine device.

### BRIEF DESCRIPTION OF THE DRAWINGS

The accompanying drawings which are incorporated in and form a part of the specification illustrate preferred embodiments of the present invention and, together with a description, serve to explain the principles of the invention. In the drawings:

FIG. 1 is a perspective view of a residential structure incorporating a wind energy conversion device constructed in accordance with the present invention;

FIG. 2 is a side perspective view, with some parts in section, of one embodiment of a wind energy conversion device constructed in accordance with the present invention;

FIG. 3 is a side perspective view of a wind collector embodiment for use with the present invention;

FIG. 4 is a cross-sectional view taken substantially along line 4-4 of FIG. 3;

FIG. 5 is a side perspective view of a second wind collector embodiment for use with the present invention;

FIG. 6 is a side perspective view of yet another wind collector embodiment for use with the present invention;

FIG. 7 is a side perspective view, with some parts in section, of a second embodiment of a wind energy conversion device constructed in accordance with the present invention;

FIG. 8 is a cross-sectional view taken substantially along line 8-8 of FIG. 7;

FIG. 9 is an enlarged, partial view of the shutter assembly of FIG. 8 in both open and closed positions;

FIG. 10 is a side sectional view of a third embodiment of a wind energy conversion device constructed in accordance with the present invention;

FIG. 11 is a front plan view taken substantially along line 11-11 of FIG. 10 illustrating the air inlet opening of this embodiment;

FIG. 12 is a partial side perspective view, with some parts in section, of yet another embodiment of a wind energy conversion device constructed in accordance with the present invention; and

FIG. 13 is a front plan view taken substantially along line 13-13 of FIG. 12 illustrating the air inlet opening of this particular embodiment.

### DETAILED DESCRIPTION OF THE EXEMPLARY EMBODIMENTS

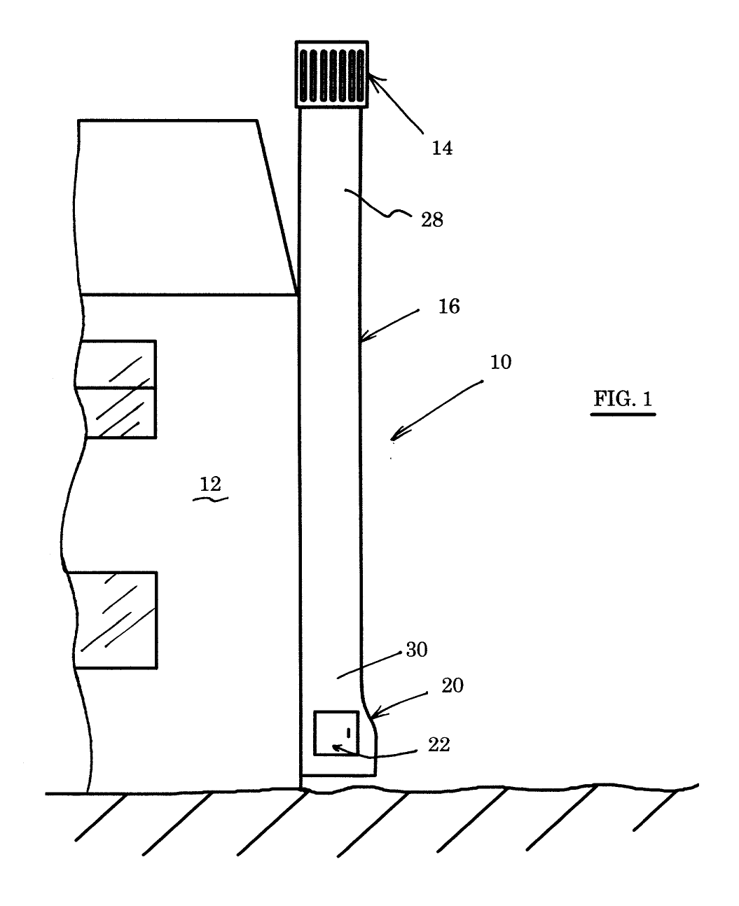

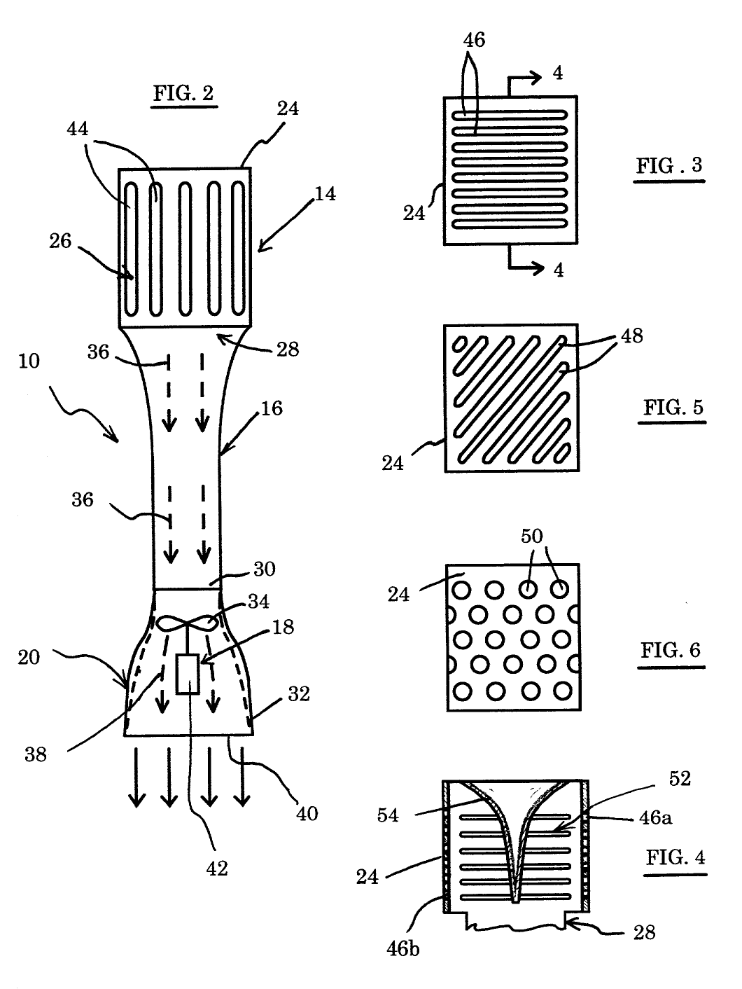

Referring first to FIGS. 1 and 2, a device 10 is illustrated for capturing and converting wind energy to electrical energy. In one preferred embodiment, the device 10 is attached to or made an integral part of a residential structure 12. It should be understood, however, that the device 10 may be associated with the residential structure 12 in any manner desired. Moreover, it may also be formed as a freestanding member apart from any particular specific structure.

In one preferred form, the device 10 includes a wind collector 14 mounted to the uppermost end of a tower 16. A wind turbine 18 is preferably mounted in the lowermost portion 20 of the tower 16. In the embodiment illustrated in FIG. 1, an access door 22 is disposed in the lowermost portion 20 to provide ready access to the turbine 18. While the tower 16 is illustrated in a preferred form wherein it is an upright, vertical member, it should be understood that the tower 16 may be oriented at any desired angle, including horizontally, in order to position the collector 14 in a manner to be exposed to and capture wind airflow.

The collector 14 preferably includes a housing 24 having an air inlet 26 therein. The collector 14 is designed to capture the wind airflow by admitting the wind airflow through opening of the air inlet 26. As discussed in further detail below, there are a number of different embodiments and designs to achieve this function. Once the wind airflow has entered the collector housing 24, it is diverted therein into the first end opening 28 of the tower 16. In preferred form, the tower 16 is a hollow tubular conduit designed to direct the airflow along its length to its second or terminal end 30. A turbine housing 32 is disposed at the terminal end 30 of the tower conduit 16 and is sized and shaped to enclose a wind turbine device 18.

While any type of appropriate wind turbine device 18 may be utilized in the present invention, a diffuser augmented wind turbine is preferred. Most preferred is a diffuser augmented turbine device manufactured by Vortec Energy. Regardless of the specific turbine utilized, it is preferably small and a mini-turbine mounted near the ground surface with its blades 34 facing the terminal end 30 of the tower 16. In this manner, airflow 36 passes along the tower 16 and into the housing 32 to rotate the blades 34 of the turbine 18. The airflow 38 then exits the end opening 40 of the housing 32. The body 42 of the turbine 18 includes components well known to the art for converting the rotation of the blades 34 to electrical energy, which is then drawn off for use as desired. Placing the wind turbine 18 near the ground makes it easy to mount, maintain and is aesthetically pleasing. Other advantages over standard turbine units is that the unit is quiet, it is enclosed by the housing 32, is low to the ground for easy access and maintenance, and presents a minimum danger to birds and other animals compared to standard windmill type of wind turbines.

Referring now to FIGS. 2-9, the collector 14 is preferably in the form of a cylindrical housing 24 having the air inlet 26 for capturing environmental wind originating from one or more directions and preferably from any direction in a 360° radius, making it omnidirectional. In one form of the invention, the air inlet 26 may include a plurality of vertically aligned and spaced slots 44. In another form of the invention, the air inlet 26 may include a plurality of horizontally aligned and spaced slots 46. In yet another embodiment, it includes a plurality of angularly aligned and spaced slots 48. In still another form of the invention, the air inlet 26 may be in the form of a plurality of openings or holes 50. Regardless of the shape and alignment of the air inlet 26 openings, the air inlet 26 enables the wind airflow to pass therethrough into the interior 52 of the housing 24.

An airflow deflector element 54 is preferably disposed within the interior of the housing 24. The purpose of the deflector element 54 is to retain the wind airflow within the housing 24 and prevent airflow from entering slots 46a, passing through the interior of the housing 24, and then exiting the opposite slots 46b. The deflector element 54 not only retains the airflow within the housing interior 52 but also deflects it to the throat or end opening 28 of the tower conduit 16. In this manner, the airflow 36 enters and passes along the length of the tower conduit 16 to the wind turbine 18.

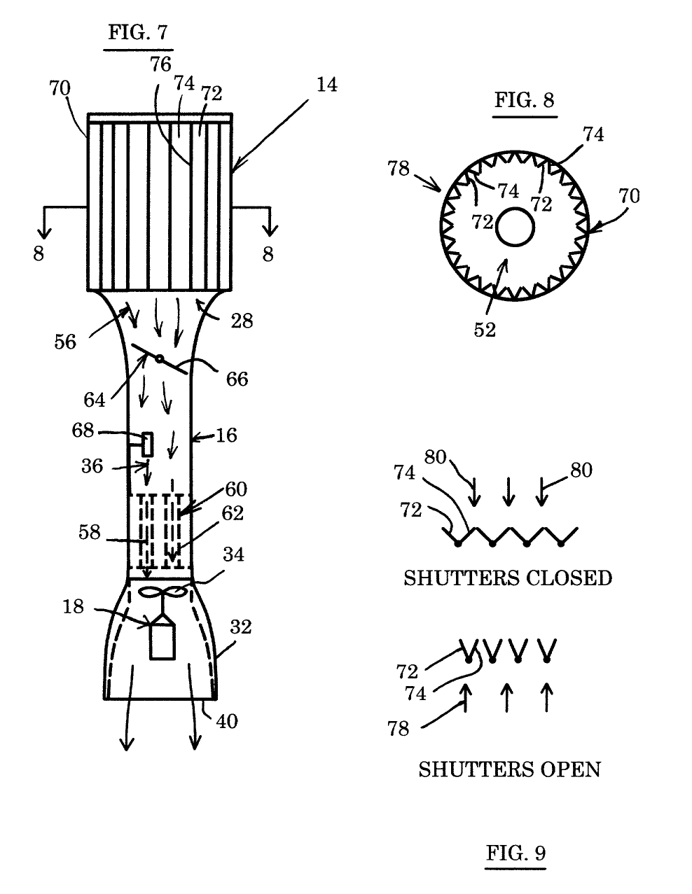

Referring particularly to FIGS. 7-9, the tower conduit 16 may include several elements for controlling the airflow therein. As previously discussed, the airflow is received by the collector 14 and then diverted into the upper end or throat 28 of the conduit tower 16. Typically, the initial airflow 56 at the throat 28 is somewhat turbulent. To maximize the efficiency of the wind turbine 18, it is preferred that the turbulent airflow 56 be dampened and form a more laminar airflow 58 prior to impacting the blades 34. To accomplish this, a plurality of airflow turbulence control elements 60 are positioned within the conduit tower 16. In preferred form, the control elements 60 are in the form of a plurality of small elongated tubes 62 packed or bundled together to fill a portion of the tower 16 so that the airflow 58 it is substantially laminar by the time it reaches the second or exit end of the tower 16. In one form of the invention, the tubes 62 are preferably approximately two inches in diameter and 1-2 feet long.

It is also important for the efficiency of the wind turbine 18 that the blades 34 not be exposed to rapid changes in airflow speed. Examples of such rapid airflow speed changes include wind gusts at the collector 14. While gradual changes of airflow speed are acceptable, sudden and dramatic changes and airflow speed are undesirable. To prevent such sudden and dramatic airflow speed changes from impacting the wind turbine 18, a dampening device 64 is preferably installed in the tower 16 preferably proximate the upper end or throat 28. In one preferred form, the dampening device 64 may be in the form of a throttle or a butterfly valve 66 capable of moving between a fully closed position to block airflow through the tower 16 and a fully open position wherein airflow through the tower 16 is substantially unaffected. Thus, by adjusting the position of the valve 66, the speed of the airflow in the tower conduit 16 may be regulated. An airflow velocity-sensing element 68 is preferably disposed within the tower conduit 16. This element 68 is adapted to automatically move the valve 66 in a manner so as to dampen and regulate speed of the airflow within the tower 16 to prevent sudden and significant airflow speed changes from impacting the wind turbine 18. In preferred form, the valve 66 is typically wide open when the airflow speed is less than 60 mph and is shuttered down and dampened as needed when the airflow speed exceeds approximately 60 mph. It should be understood that other adaptations of airflow speed control mechanisms as well as airflow turbulence dampening devices may be utilized with the present invention.

Another embodiment of the collector 14 is illustrated in FIGS. 7-9. In this particular embodiment, the collector 14 is in the form of a substantially cylindrical housing 70. A plurality, in the form of an array, of paired shutters 72,74 are preferably disposed about the perimeter of the housing 70. Each pair of shutters 72,74 are preferably made from a flexible plastic or similar material pivotally mounted to each other by a hinge member or living hinge 76. In this manner, when environmental wind 78 impacts the exterior of the housing 70 and the exterior surfaces of the shutters 72,74, the shutters 72,74 open permitting the wind airflow to enter the interior 52 of the housing 70. In this particular embodiment, the airflow deflector function is accomplished in part by the shutters 72, 74 themselves. As the wind airflow enters the interior 52 of the housing 70 and impacts the interior surfaces of the shutters 72,74 as illustrated by the arrows 80, the impacted shutters 72,74 are held in a closed position thereby preventing the airflow from exiting the interior 52 of the housing 70 except through the throat 28 into the tower 16.

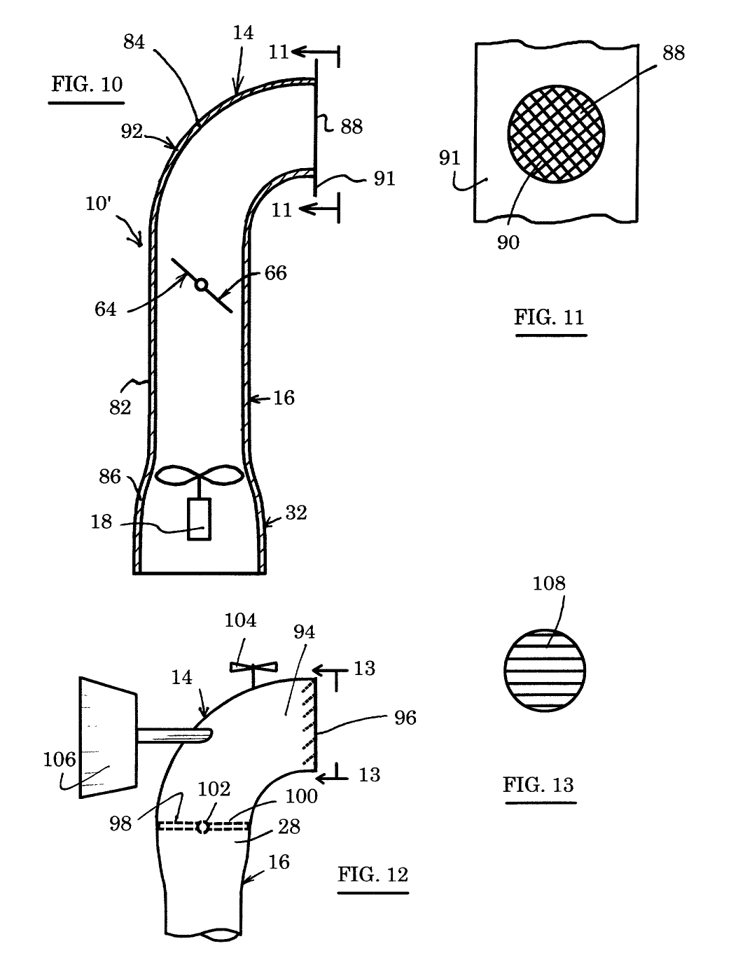

Referring now to FIGS. 10-11, another embodiment of the present invention is illustrated herein. In the prior embodiments discussed above, the wind collector 14 is omnidirectional, meaning that the collector 14 may capture environmental wind airflow regardless of the origin of direction from which the wind is coming. In these embodiments, a prevalent wind direction is unnecessary since the device of the invention may capture wind airflow from any direction. The device 10′ is a variation wherein it is designed to receive environmental wind airflow from one primary, prevalent wind direction. This particular embodiment is especially useful in certain parts of the country where prevalent winds from one direction are common.

In this embodiment, the wind tower 16 is integrated with the collector 14 and the turbine housing or shroud 32 to form a unitary structure. The tower 16 is in the form of a hollow conduit 82, and the collector 14 is in the form of a hollow conduit 84 that is angularly shaped, preferably at a substantially right angle as in an elbow joint. The lower portion 86 to of the conduit 82 is flared to form the shroud or housing 32 in which the wind turbine 18 is mounted as previously described. The conduit collector 84 terminates in a single large opening 88 into which the environmental wind airflow passes. A screen 90 or other similar type of mesh cover is mounted across the opening 88 to prevent entry of birds or other wild animals. The curved or angular portion 92 of the collector conduit 84 functions as the airflow deflection element to direct wind airflow from the opening 88 down into the tower 16. This particular embodiment may be readily integrated within a building structure such that the opening 88 is accessed through an outside wall 91.

A modification of the above is illustrated in FIGS. 12-13 wherein the embodiment of FIGS. 10-11 is adapted for omnidirectional wind reception. In this particular embodiment, the collector 14 is in the form of a hollow angular duct 94 having a first end opening 96 adapted to receive and environmental wind airflow and a second end opening 98 at substantially right angles to the end opening 96. The second end opening 98 is adapted to snugly fit within the end opening or throat 28 of the tower 16. This junction 100 between the respective end openings 28, 98 is adapted to permit the angular collector 94 to rotate a complete 360-degrees about the throat 28 of the tower 16, thereby making the collector 94 omnidirectional. If it is desired to fix the relative position of the collector 94 so as to direct it toward a prevalent wind direction, a tightening member 102 may be engaged. Thus, the collector 94 may be either fixed or omnidirectional depending on the needs of the situation.

In order for the collector 94 to be omnidirectional, a wind direction sensor 104 may be mounted to the collector 94 and used to variably direct the opening 96 toward and into the environmental wind regardless of the direction from which it is coming. Alternatively, a tail fin member 106 may be mounted to the collector 94 opposite the opening 96 so that wind impacting the tail fin member 106 will turn and maintain the opening 96 facing into the environmental wind. Preferably, a plurality of louvers 108 are mounted across the opening 96. The louvers 108 are secured in a manner that maintains them in a closed position unless a wind airflow impacts the exterior surfaces thereof. In this situation, the wind airflow pushes the louvers 108 open and permits the wind airflow to enter the collector 94. The louvers 108 serve the same function as the mesh or screen 90 of the previous embodiment in that they keep birds and other animals from entering the opening 96.

The concept of the present invention utilizes a diffuser augmented wind turbine mounted in a vertical orientation and positioned near the ground. Since it is mounted proximate to the ground surface, it is used in a vertical wind tower to collect the wind and direct it downwardly through the turbine blades. The unit of the present invention is particularly useful for installation on an average single-family home. In any of the embodiments, the present invention takes up little ground space and an be integrated into new home designs by mounting on the roof as well. These devices can also be constructed to blend in more with the environment and residential structures. The wind power concept of the invention allows the present device to be as tall as is necessary to eliminate interference from surrounding buildings and trees. In preferred form, it is omnidirectional in that it has a 360-degree view and therefore can handle wind from any direction. The interior airflow shutter feature of the invention allows it to handle high winds without any negative effect and can in fact work effectively and efficiently in high wind areas. It can handle substantial wind gusts and has a flowing smoothing feature to it which further increases the performance of the turbine.

In comparison, photovoltaic systems rated at 1,000 watts peak collect approximately 5 kilowatts per day or 1800 kilowatts per year. With a 20 percent typical loss due to batteries and inverter, the 5 kW become 4 kilowatts and the 1800 kilowatts become 1,450 kilowatts per year. While the wind doesn't blow five hours a day on average, it does blow at night intermittently at a time when the sun doesn't shine. Consequently, the average kilowatts collected by the wind tower system of the invention compares favorably with the photovoltaic system. The average residential user consumes approximately 8000 kilowatts per year. With utility-based wind power and the present invention, the average residential user in 37 states could be supplied with approximately 36% of their entire energy needs by wind power using the present invention.

The energy regeneration system of the present invention is estimated to cost approximately $3,500.00 per 1000 watts peak. In comparison, a typical photovoltaic solar system installation costs approximately $7,000.0 per 1000 watts peak with batteries and inverter. The system of the present invention thus is approximately 50% of the cost of present photovoltaic systems. Moreover, photovoltaic systems are difficult to install on existing homes when considering variables such as sun direction, roof loading, supports and maintenance. Having the working parts of the present invention at ground level solves these maintence issues. It is believed that the present invention can be installed on nearly 80% of the single-family residences in the United States.

As can be seen from the above, the present invention provides a system for capturing and harnessing environmental wind energy in an effective and efficient manner. The present invention eliminates unsightly and noisy windmill systems previously used. Moreover, the present invention provides a system that is adaptable for use with individual residential structures and may be integrated into a new structure or added onto an existing structure. The device of the invention is designed to operate even at times of high, gusty winds unlike prior wind power devices which automatically shut down during such situations. Additionally, the present invention is designed to be easily maintained while eliminating interaction with birds and other animal life. Finally, the present invention provides an efficient, inexpensive and practical alternative for generating energy from a renewable energy resource.

The foregoing description and the illustrative embodiments of the present invention have been described in detail in varying modifications and alternate embodiments. It should be understood, however, that the foregoing description of the present invention is exemplary only, and that the scope of the present invention is to be limited to the claims as interpreted in view of the prior art. Moreover, the invention illustratively disclosed herein suitably may be practiced in the absence of any element which is not specifically disclosed herein.

I claim:

1. An apparatus for capturing and converting wind energy to electrical energy, said apparatus comprising:
a tower member arranged in the form of an elongated conduit having first and second end portions;
a wind collector associated with said conduit first end portion and having an air inlet to capture environmental wind originating from one or more directions and deflect the captured wind into said conduit to create an axial airflow therein; and
a wind turbine device disposed at said conduit second end portion for receiving said airflow from said conduit to generate electricity therefrom.

2. The apparatus as claimed in claim 1, wherein said apparatus further comprises an airflow velocity sensing element disposed in said conduit for measuring the airflow speed therein, and an airflow speed control member disposed proximate said conduit first end portion to selectively restrict and dampen the speed of the airflow received by said turbine device from said conduit in response to variable speed changes in and gusts of environmental wind impacting said collector air inlet conduit.

3. The apparatus as claimed in claim 2, wherein said airflow speed control member comprises a dampening device disposed in said conduit to prevent sudden impact of airflow onto said wind turbine device resulting from substantial gusts of environmental wind entering said wind collector, said dampening device being selectively movable between a full open position unaffecting conduit airflow speed to a full closed position blocking conduit airflow entirely.

4. The apparatus as claimed in claim 1, wherein said wind collector comprises a housing communicating with said conduit first end portion, an air inlet assembly disposed in said housing and adapted to direct wind airflow into said housing, and a wind airflow deflection arrangement for retaining the wind airflow captured by said air inlet assembly within said housing and diverting it into said conduit.

5. The apparatus as claimed in claim 4, wherein said air inlet assembly includes a mechanism for preventing the entry of living creatures into said housing.

6. The apparatus as claimed in claim 4, wherein said air inlet assembly is omni-directional.

7. The apparatus as claimed in claim 6, wherein said housing comprises a substantially cylindrical element, and said air inlet assembly is defined by a plurality of spaced openings disposed along the perimeter of said cylindrical element and accessing the interior thereof.

8. The apparatus as claimed in claim 6, wherein said housing comprises a cylindrical element, and said air inlet assembly comprises an array of elongated paired shutters disposed about the perimeter of said cylindrical element, said paired shutters being adapted for movement between a closed position blocking access to the interior of said housing by both the absense of wind pressure against the exterior surfaces of said shutters as well as the presence of wind pressure against the interior surfaces of said shutters, and an open position for accessing the interior of said housing by radially inward rotation thereof in response to wind pressure against the exterior surfaces of said shutters.

9. The apparatus as claimed in claim 4, wherein said housing comprises an angular-shaped tubular element having first and second end sections and a curved angular central section therebetween, said first end section being coupled to said conduit first end portion for rotational movement relative thereto, and said second end section comprising said air inlet assembly in the form of an annular opening for receiving environmental wind directed thereinto, said curved angular central section comprising said wind airflow deflection arrangement.

10. The apparatus as claimed in claim 9, wherein said collector further comprises a sensing member mounted to said housing for detecting environmental wind direction and rotating said air inlet assembly annular opening into the environmental wind airflow regardless of the direction from which the environmental wind airflow originates.

11. The apparatus as claimed in claim 9, wherein said collector further comprises a mechanism for selectively fixing the rotational position of said first end section relative to said conduit first end portion to orient said air inlet assembly annular opening toward a predominant environmental wind direction.

12. The apparatus as claimed in claim 9, wherein said air inlet assembly further comprises a plurality of louver fins disposed across said annular opening to control the flow of wind into said air inlet assembly.

13. The apparatus as claimed in claim 1, wherein said tower comprises a substantially vertical tube.

14. The apparatus as claimed in claim 13, wherein said tower tube further includes a plurality of airflow turbulence control elements disposed therein to create laminar airflow along the length of said tower tube prior to impacting said wind turbine device.

15. A wind energy conversion device for capturing and redirecting wind airflow and converting the energy therefrom to electrical energy, said device comprising:
a tower member arranged in the form of an elongated substantially hollow airflow conduit having first and second end portions;
a wind collector associated with said conduit first end portion and having an omni-directional air inlet to capture environmental wind originating from any compass direction and deflect the captured wind into said conduit to create a substantially axial airflow therein;
airflow turbulence control elements disposed within said conduit to create substantially laminar airflow along the length thereof; and
a wind turbine device disposed at said conduit second end portion for receiving said substantially laminar airflow from said conduit to generate electricity therefrom.

16. The device as claimed in claim 15, wherein said device further comprises an airflow velocity sensing element disposed in said conduit for measuring the airflow speed therein, and an airflow speed control member disposed proximate said conduit first end portion to regulate the speed of said airflow in said conduit in response to variable speed changes in and gusts of environmental wind impacting said collector air inlet to prevent sudden speed changes in the airflow impacting said turbine device.

17. The device as claimed in claim 16, wherein said airflow speed control member comprises a dampening device disposed in said conduit to prevent sudden impact of airflow onto said wind turbine device resulting from substantial gusts of environmental wind entering said wind collector, said dampening device being selectively movable between a full open position unaffecting conduit airflow speed to a full closed position blocking conduit airflow entirely.

18. The device as claimed in claim 15, wherein said device is adapted for association with a residential housing unit, and said tower member comprises a substantially vertical tube.

19. The device as claimed in claim 18, wherein said tower member is incorporated as an integral component of a residential housing unit with said conduit second end portion and wind turbine device being disposed at ground level.

20. The device as claimed in claim 18, wherein said wind collector air inlet includes a mechanism for preventing the entry of living creatures therein.

21. The device as claimed in claim 15, wherein said wind collector comprises a substantially cylindrical housing communicating with said conduit first end portion, an air inlet assembly defined by a plurality of spaced slots disposed along the perimeter of said housing and arranged to admit wind airflow into the interior thereof, and a wind airflow deflection arrangement for retaining the wind airflow captured by said air inlet assembly within said housing and diverting it into said conduit.

22. The device as claimed in claim 15, wherein said wind collector comprises a substantially cylindrical housing communicating with said conduit first end portion, an air inlet assembly comprising an array of elongated paired shutters disposed about the perimeter of said housing and adapted to admit wind airflow into said housing, said paired shutters being adapted for movement between a closed position blocking access to the interior of said housing by both the absense of wind pressure against the exterior surfaces of said shutters as well as the presence of wind pressure against the interior surfaces of said shutters, and an open position for accessing the interior of said housing by radially inward rotation thereof in response to wind pressure against the exterior surfaces of said shutters, and a wind airflow deflection arrangement for retaining the wind airflow captured by said air inlet assembly within said housing and diverting it into said conduit.

23. The device as claimed in claim 15, wherein said wind collector comprises an angular-shaped tubular housing having first and second end sections and a curved angular central section therebetween, said first end section being coupled to said conduit first end portion for rotational movement relative thereto, an air inlet assembly in the form of said tubular element second end section adapted to admit wind airflow into said housing and having an annular opening for receiving environmental wind directed thereinto, and a wind airflow deflection arrangement for retaining the wind airflow captured by said air inlet assembly within said housing and diverting it into said conduit, said curved angular central section comprising said wind airflow deflection arrangement, and wherein said collector further comprises a sensing member mounted to said housing for detecting environmental wind direction and rotating said air inlet assembly annular opening into the environmental wind airflow regardless of the direction from which the environmental wind airflow originates.

24. A wind tower device for generating electrical energy for residential use by capturing and harnessing wind energy, said wind tower device comprising:
a tower member arranged in the form of an elongated substantially vertically oriented airflow conduit having first and second end portions;
a wind collector associated with said conduit first end portion and having an air inlet assembly adapted to capture local environmental wind and a wind airflow deflection arrangement to deflect the captured wind into said conduit to create a substantially downward axial airflow therein;
airflow turbulence control elements disposed within said conduit to create substantially laminar airflow along the length thereof;
a wind turbine device disposed at said conduit second end portion proximate a ground surface for receiving said substantially laminar airflow from said conduit to generate electricity therefrom;
an airflow velocity sensing element disposed in said conduit for measuring the airflow speed therein; and
an airflow speed control member disposed proximate said conduit first end portion to regulate the speed of said airflow in said conduit in response to variable and gusting speed changes in the environmental wind impacting said collector air inlet to prevent sudden speed changes in the airflow impacting said turbine device.

25. The device as claimed in claim 24, wherein said airflow turbulence control elements comprise a plurality of elongated baffle tube members disposed longitudinally within said conduit downstream from said airflow speed control member for reducing the turbulence and increasing the laminar flow of said airflow as said airflow approaches said wind turbine device.

26. The device as claimed in claim 25, wherein said airflow speed control member comprises a dampening device disposed in said conduit to prevent sudden impact of airflow onto said wind turbine device resulting from substantial gusts of environmental wind entering said wind collector, said dampening device being selectively movable between a full open position unaffecting conduit airflow speed to a full closed position blocking conduit airflow entirely.

27. The device as claimed in claim 24, wherein said wind collector comprises a substantially cylindrical housing communicating with said conduit first end portion, said air inlet assembly being defined by a plurality of spaced slots disposed along the perimeter of said housing and arranged to admit wind airflow into the interior thereof, and said wind airflow deflection arrangement comprising a curved airflow diverter element disposed at the interior center of said housing for retaining the wind airflow passing through said air inlet assembly slots into said housing and diverting it downwardly into said conduit.

28. The device as claimed in claim 24, wherein said wind collector comprises a substantially cylindrical housing communicating with said conduit first end portion, wherein said air inlet assembly comprises an array of elongated paired shutters disposed about the perimeter of said housing adapted to admit wind airflow into said housing, said paired shutters being arranged for movement between a closed position blocking access to the interior of said housing defined by the absense of wind pressure against the exterior surfaces of said shutters as well as the presence of wind pressure against the interior surfaces of said shutters, and an open position for accessing the interior of said housing by radially inward rotation thereof in response to wind pressure against the exterior surfaces of said shutters, and wherein said wind airflow deflection arrangement comprises the interior surfaces of said shutters within said housing retaining the wind airflow captured by said air inlet assembly within said housing resulting from being retained in their closed positions in response to the presence of wind pressure against their interior surfaces and diverting said airflow into said conduit.

29. The device as claimed in claim 24, wherein said wind collector comprises an angular-shaped tubular housing having first and second end sections and a curved angular central section therebetween, said first end section being coupled to said conduit first end portion for rotational movement relative thereto, wherein said air inlet assembly comprises said tubular element second end section having an annular opening for receiving environmental wind directed thereinto adapted to admit wind airflow into said housing, and wherein said wind airflow deflection arrangement comprises said curved angular central section adapted for retaining the wind airflow captured by said air inlet assembly annular opening and angularly diverting it into said conduit, and wherein said collector further comprises a sensing member mounted to said housing for detecting environmental wind direction and rotating said air inlet assembly annular opening into the environmental wind airflow regardless of the direction from which the environmental wind airflow originates.

30. The device as claimed in claim 29, wherein said wind collector further comprises a mechanism for selectively fixing the rotational position of said first end section relative to said conduit first end portion to orient said air inlet assembly annular opening toward a predominant environmental wind direction.
